(19) United States
(12) Patent Application Publication
(10) Pub. No.: US 2008/0291859 A1
(43) Pub. Date: Nov. 27, 2008

(54) Fm Multiplex Broadcasting System, Fm Multiplex Broadcasting Method, and Receiver

(75) Inventor: Masayoshi Son, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SOFTBANK BB CORP., Minato-ku, Tokyo (JP)

(21) Appl. No.: 11/571,013

(22) PCT Filed: Jun. 23, 2005
(86) PCT No.: PCT/JP2005/011540

§ 371 Date: Sep. 27, 2007

(30) Foreign Application Priority Data
Jun. 24, 2004 (JP) 2004-186048

(51) Int. Cl. H04J 15/00

(52) U.S. Cl. 370/312; 455/352

(57) ABSTRACT

An FM multiplex broadcasting system includes a central server for creating or managing data for FM multiplex broadcast and community servers connected to the central server over the Internet. The data for FM multiplex broadcast is transmitted from the central server to the community servers to provide FM multiplex broadcast containing the data for FM multiplex broadcast to specific areas through the community servers. With this, only specific information out of a content broadcasted by FM broadcast under viewers' condition can be reproduced or stored.

### TECHNICAL FIELD

The present invention relates to an FM multiplex broadcasting system, an FM multiplex broadcasting provision method and a receiver in which only particular information can be played back or stored in accordance with the condition given by the viewer.

### BACKGROUND ART

FM multiplex broadcasts are FM broadcasts which transmit sound signals together with text information associated therewith. When a broadcast is received by a receiver (for example, radio) which supports it, text information such as news, weather forecast, traffic information and so forth is displayed on a display. It is possible to display the title and artist name of a musical piece which is being played back. This service was begun in 1996, following a recommendation by Radio Regulatory Council issued in 1994.

In the case of FM multiplex broadcasting, text information is digitized and superimposed at a frequency which is a little higher than the frequency of the stereo audio signals of FM broadcasting. The amount of text information is several orders of magnitude less than that of the sound information, and thereby there is little effect on the sound quality. For example, Japanese Patent Published Application No. Tokukai Hei 6-252790 discloses an example of the receiver for FM multiplex broadcast.

This publication discloses an FM multiplex receiver making use of identification codes for identifying multiplexed broadcast programs contained in the multiplexed data which is superimposed in and transmitted as FM broadcast signals, and comprising a storing unit, an identification code detector unit for detecting said identification codes and storing them in said storing unit, a manipulation unit, a display control unit for displaying, on a display unit, titles made of character strings or the like corresponding to the identification codes stored in said storing unit in response to the manipulation of said manipulation unit, and a multiplexed program selection unit for selecting a multiplexed broadcast program and storing the multiplexed broadcast program in said storing unit on the basis of the identification code of one of the titles displayed on said display unit, when the one of the titles is selected by said manipulation unit.

In accordance with the receiver as described above, it is possible to display, in the display unit, character strings or the like corresponding to the identification codes as detected from the multiplexed data of an FM multiplex broadcasting signal, and when one of the titles displayed on said display unit is selected by said manipulation unit, it is possible to select a multiplexed broadcast program on the basis of the identification code of that title and store it in said storing unit, so only necessary multiplex broadcast program data can automatically be stored.

Patent Document 1: Japanese Patent Published Application No. Tokukai Hei 6-252790

### DISCLOSURE OF THE INVENTION

However, even if broadcast content can not only aurally but also visually be recognized by the use of the display of a receiver as has been discussed above, there is a probability of failing to hear and looking the other way. Particularly, when it is desired to record a particular musical piece while listening to a musical program, it is difficult to know when the musical piece starts and when the musical piece ends, and in addition to this, the manipulation for recording must be performed by hand with a remote control and the like, so that there is a problem in that it is difficult to perform necessary manipulation at an appropriate timing for recording the desired musical piece.

Incidentally, it is also possible to make use of a schedule table of FM broadcasts which is sold at a market, however, it is difficult to find out a desired musical piece from all of the music titles of the schedule table, and in the case where information items which are desired to be recorded are broadcasted in overlapped time slots, there is a problem in that either one of information items cannot be recorded.

Furthermore, in the case of the invention described in Patent Document 1 as described above, there is a problem in that, while it is possible to record the respective broadcast programs separately from each other, it is not possible to selectively record only necessary information.

The present invention is invented taking into consideration the above circumstances and serves to provide an FM multiplex broadcasting system, an FM multiplex broadcasting provision method and a receiver in which only particular information can be played back or stored in accordance with the condition given by the viewer.

The present invention provides an FM multiplex broadcasting system comprising: a central server operable to create or manage data for FM multiplex broadcast; and a community server connected to said central server by wired or wireless connections, wherein said data for FM multiplex broadcast is transmitted from said central server to said community server, and wherein an FM multiplex broadcast containing said data for FM multiplex broadcast is provided for a particular area through said community server.

Also, another invention provides an FM multiplex broadcasting provision method comprising: a step of creating or managing data for FM multiplex broadcast on a central server side; a step of transmitting said data for FM multiplex broadcast from said central server to a community server located in each area; and a step of providing an FM multiplex broadcast containing said data for FM multiplex broadcast for a particular area through said community server.

A further invention provides a receiver for FM multiplex broadcasts including content data and index data, comprising: a receiving unit operable to receive said FM multiplex broadcasts; a condition setting unit which is used to input the condition for searching said index data; a search unit operable to search said index data on the basis of said search condition; and a storage unit operable to store desired content data on the basis of the search result.

In the invention as described above, said data for FM multiplex broadcast may be data into which is inserted information provided on said community server such as information which is closely related to the respective areas.

It is preferred that said data for FM multiplex broadcast is composed of content data and index data which includes information about said content data, and that said index data is broadcasted a predetermined period before said content data is broadcasted.

In this case, the index data may contain, as the information about the content data, the title of music, the broadcast start time, the broadcast end time, the length of music, and may contain an artist name, a musical genre, song lyrics, a music title, or keyword(s) of the artist.

It is preferred that the receiver of the invention as described above is provided with a playback unit operable to play back desired content data on the basis of said search result, and a display for displaying desired index data on the basis of said search result.

### BRIEF DESCRIPTION OF THE DRAWINGS

FIG. 1 is a view for schematically showing the configuration of an FM multiplex broadcasting system in accordance with an embodiment.

FIG. 2 is a view for showing having the structure of data for FM multiplex broadcast of the embodiment.

FIG. 3 is a block diagram for schematically showing the receiver of the embodiment.

FIG. 4 is a flow chart for showing the FM multiplex broadcasting provision method in accordance with the embodiment.

FIG. 5 is a flow chart for showing the recording method by the use of the receiver of the embodiment.

### BEST MODE FOR CARRYING OUT THE INVENTION

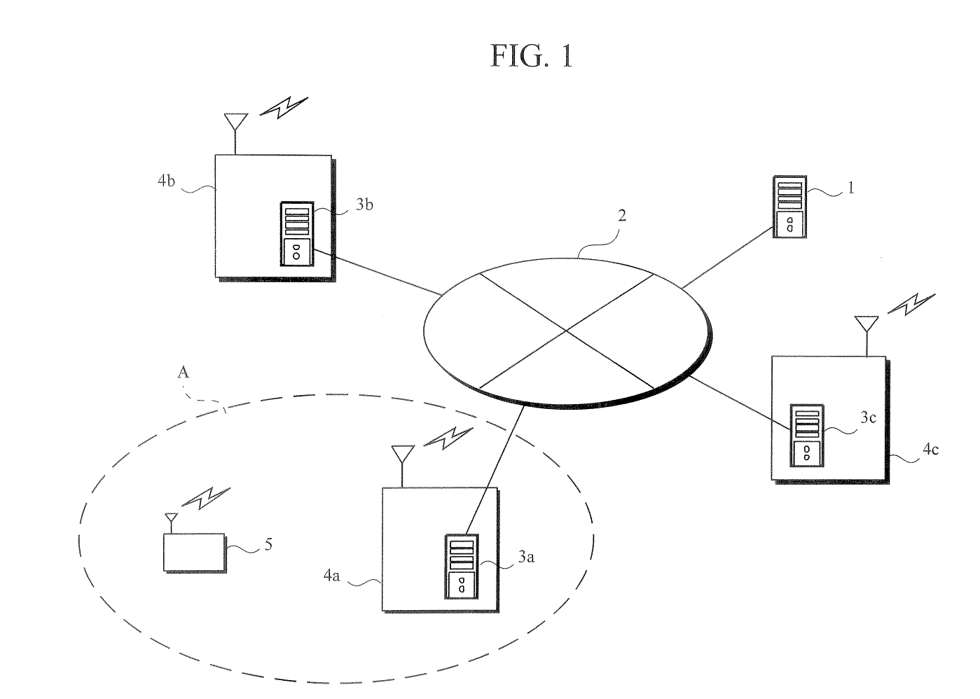

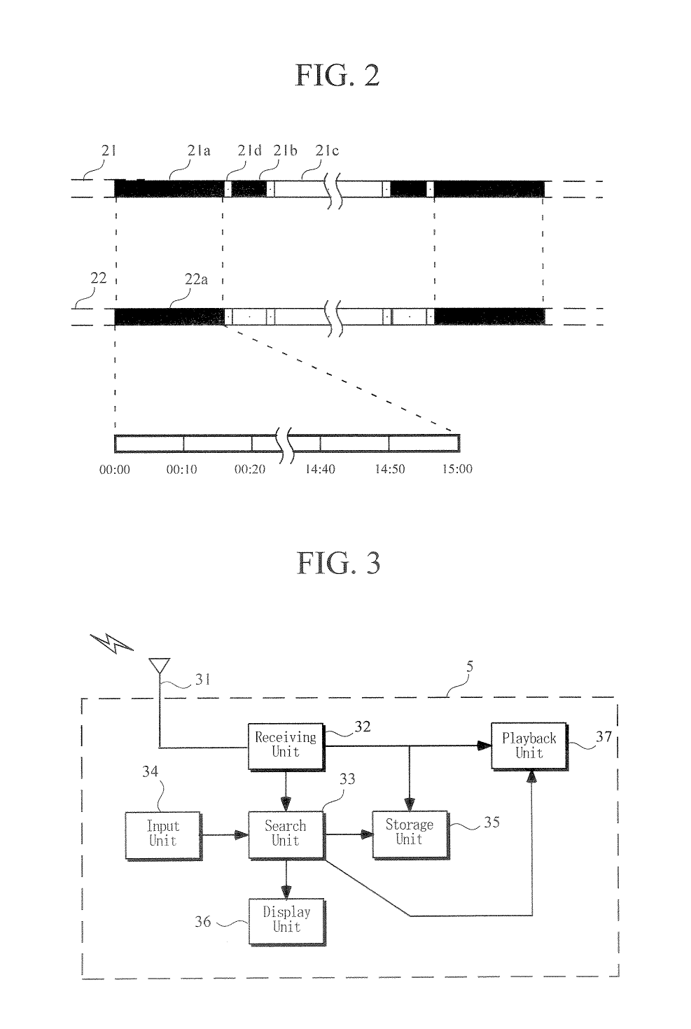

In what follows, a preferred embodiment in accordance with the present invention will be explained with reference to FIG. 1 through FIG. 5. In this case, FIG. 1 is a view for schematically showing the configuration of an FM multiplex broadcasting system in accordance with the present embodiment; and FIG. 2 is a view for showing the structure of data for FM multiplex broadcast.

As illustrated in the same figure, the FM multiplex broadcasting system of the present embodiment is provided with a central server 1 for creating and managing the data for FM multiplex broadcast, and community servers 3a, 3b and 3c connected to the central server 1 through the Internet 2, and operable to transmit the data for FM multiplex broadcast from the central server 1 to the community servers 3a, 3b and 3c in order to provide FM multiplex broadcasts with the data for FM multiplex broadcast for particular areas (for example, area A) through the community servers 3a, 3b and 3c.

The central server 1 serves to provide the data for FM multiplex broadcast as illustrated in FIG. 2 through the Internet 2 for the community servers 3a, 3b and 3c. The data for FM multiplex broadcast may be created by the central server 1 or another terminal.

The Internet 2 is a distributed communication network which is constructed by connecting the communication networks all over the world to each other by the use of the communication protocol TCP/IP, so that a variety of terminal organizations can mutually exchange packet data by the use of TCP/IP. The internet 2 as described above may be wired or wireless connected.

The community servers 3a, 3b and 3c are servers installed in community FM stations 4a, 4b and 4c. The community FM stations 4a, 4b and 4c are not ordinary FM stations to which frequency bands as assigned in prefectures, but are broadcast stations to which frequency bands as assigned in cities and towns for providing detailed information relating to limited local areas for the purpose of revitalizing the local areas. The transmission power is substantially low up to a maximum of 20 W. This kind of the community FM stations 4a, 4b and 4c was introduced in 1992 and, at present, 140 or more stations have started broadcasting all over Japan. For example, the community FM station 4a serves to provide FM broadcasting for a receiver 5 in the area A.

The data for FM multiplex broadcast is composed of content data 21 and index data 22 as shown in FIG. 2.

The content data 21 contains program data 21a, CM data 21b, blank data 21c and so forth, and there are flags 21d between adjacent items of the data respectively. The content data 21 is the content of a broadcasting service which is provided in each area as a so-called FM broadcast. In the case of a music program, the program data 21a contains voice data such as a disc jockey talk and the data relating to the musical piece which is played in the program. In addition, the blank data 21c can be used in the community FM station 4a, 4b and 4c to insert information (a program, traffic information, weather forecast, and the like) which is closely related to the respective areas. This operation can be performed by the community servers 3a, 3b and 3c or another terminal.

Information data 22a is inserted into the index data 22 in synchronization with the program data 21a. For example, in the case where the program data 21a is provided as a music program, the information data 22a is composed of the title, artist name, broadcast start time, broadcast end time, length and other relevant data of the musical piece which is played back in the program. In addition to this, the information data 22a is divided by time stamps into predetermined time periods in order that the index data 22 is given to the receiver 5 in advance of starting the broadcast by providing the program data 21a. Furthermore, the information data 22a can be designed to contain a musical genre, song lyrics, a music title, or keyword(s) of the artist. As the information data 22a contains a larger amount of information, it is possible to search for information in accordance with the preferences of the viewer by the use of the receiver 5 to be described below, and automatically record only necessary information in the program. Incidentally, while the time stamp is given for every 10 seconds in FIG. 2, the period is not limited thereto but can be set to 5 seconds, 15 seconds or any arbitrary period.

It is possible to identify particular information in accordance with the condition given by the viewer by the use of the index data 22 for FM multiplex broadcast, and play back or store only the particular information contained in the content data 21 on the basis of the identification result.

The receiver 5 is a receiver for FM multiplex broadcast comprising the content data 21 and the index data 22, and provided with a receiving unit for receiving FM multiplex broadcasts, a condition setting unit for inputting the condition for searching the index data 22, a search unit for searching the index data 22 on the basis of the search condition, a storage unit for storing a desired item of the content data 21 on the basis of the search result, a playback unit for playing back the content data, and a display for displaying the index data.

FIG. 3 is a schematic block diagram thereof. As shown in the same figure, the receiver 5 is composed of an antenna 31 for receiving FM multiplex broadcasts, the receiving unit 32 for separating the data for FM multiplex broadcast as received into the content data 21 and the index data 22, decoding the data and other necessary processing, the search unit 33 for searching the index data 22 as to whether or not desired keyword(s) are contained therein, an input unit 34 for inputting keyword(s) in the search unit 33, the storage unit 35 for performing recording operation on the basis of the result of the search unit 33, a display unit 36 for displaying the index data 22 as received on the display, and the playback unit 37 for playing back the content data 21 as received. By this configuration, the viewer can receive FM multiplex broadcasts, and automatically record information (for example, music) corresponding to the keyword(s) which are set by the viewer.

The receiving unit 32 is composed of a PLL circuit for outputting a predetermined voltage signal corresponding to the FM broadcast station to be received, an FM front end for receiving FM broadcasting signals from the antenna 31 and generating a predetermined intermediate frequency signal on the basis of the predetermined voltage, an intermediate frequency detecting amplifier for amplifying the intermediate frequency signal in order to perform detection, and so forth.

The search unit 33 is composed of a CPU which performs comparison between the index data 22 and the keyword(s) input from the input unit 34 and outputs an instruction to the storage unit 35 as to what information of the content data 21 is to be recorded.

The input unit 34 can be used to input character data into the search unit 33, and may be an input board provided on the main unit of the receiver 5, a remote control or a keyboard.

The storage unit 35 is composed of a buffer memory for temporarily storing the content data 21, or an HD, a CD device, an MD device, a DVD device or the like device for fixedly storing data.

The display unit 36 takes control to display the index data 22 as received on the display. The display unit 36 can select whether or not to display the index data 22, and display the index data 22 only when the index data 22 matches the desired keyword(s) which are input through the input unit 34.

The playback unit 37 is composed, for example, of an MPX for demodulating the detected signal which is input from the intermediate frequency detecting amplifier into stereo signals, an amplifier for amplifying the stereo signals, a speaker for outputting a sound signal, and so forth. The playback unit 37 can select whether or not to play back the content data 21 as received, and can play back only the content data 21 designated in the storage unit 35 on the basis of the result of the search unit 33.

The receiver 5 as described above is only an example, but can be provided with a CD playback mechanism, an MD playback mechanism, a cassette tape playback and recording mechanism, a timer function and so forth which are provided in conventional audio equipments, and it may be a personal computer in which a tuner board for receiving FM multiplex broadcasts is installed, or a personal computer to which a USB tuner is connected.

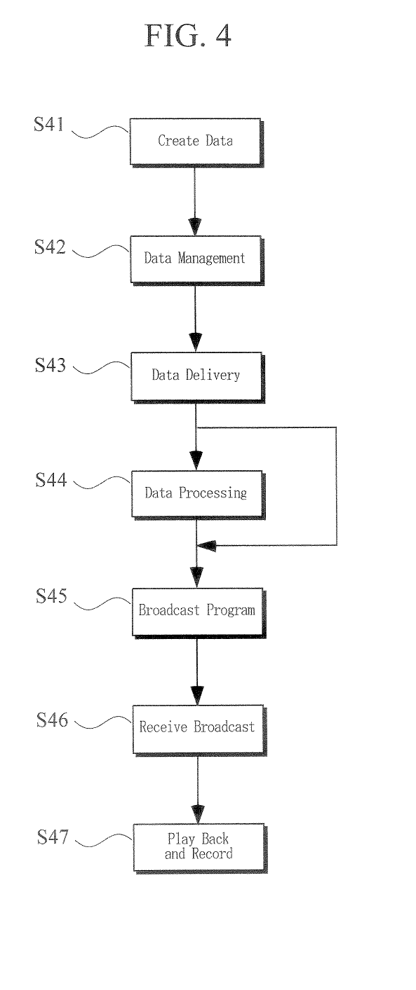

Next, the FM multiplex broadcasting provision method by the use of the FM multiplex broadcasting system in accordance with the present embodiment will be explained. FIG. 4 is a flow chart for showing the FM multiplex broadcasting provision method in accordance with the present embodiment.

As shown in the same figure, the FM multiplex broadcasting provision method of the present embodiment comprises a step (S41) of creating data for FM multiplex broadcast, a step (S42) of managing the data for FM multiplex broadcast as created in the central server 1, a step (S43) of delivering the data for FM multiplex broadcast from the central server 1 to the community servers 3a, 3b and 3c which are located in the respective areas, a step (S44) of processing the data for FM multiplex broadcast in the respective community FM stations 4a, 4b and 4c, and a step (S45) of broadcasting a program by transmitting the data for FM multiplex broadcast to the areas which are managed by the community FM stations 4a, 4b and 4c respectively.

Also, the viewer can receive the program as broadcasted in step (S46) from the data for FM multiplex broadcast which is broadcasted in the above step (S41) to step (S45) by the use of the receiver 5 as discussed above in step (S46), and can play back the program as received and record desired information in step (S47).

In step (S41), the content data 21 and the index data 22 as shown in FIG. 2 are created. In this case, for example, in the case of a music program, the index data 22 is created in order to contain, at least, the title, artist name, broadcast start time, broadcast end time, length and other relevant data of the musical piece which is played back in the program, and may be created in order to contain a musical genre, song lyrics, a music title, or keyword(s) of the artist. This creating process can be performed by the central server 1 or another terminal.

In step (S42), the central server 1 performs the management of the data for FM multiplex broadcast created in step (S41) as to which of the community servers 3a, 3b and 3c is the destination of delivery, and when it is delivered.

In steps S43, the data for FM multiplex broadcast is delivered to a predetermined server(s) of the community servers 3a, 3b and 3c through the Internet in accordance with the schedule managed in step (S42).

In step (S44), information (a program, traffic information, weather forecast, and the like) which is closely related to the respective areas of the community FM stations 4a, 4b and 4c is inserted into the blank data 21c of the content data 21.

This operation can be performed by the community servers 3a, 3b and 3c or other terminals. Incidentally, in the case where the content data 21 need not be processed at the community FM stations 4a, 4b and 4c, step (S44) can be omitted.

In step (S45), the data for FM multiplex broadcast created in step (S44) is broadcasted to each area in accordance with the schedule of the respective community FM stations 4a, 4b and 4c.

As has been discussed above, by centrally creating and managing the index data 22 on the central server 1 side, it is possible to provide a FM multiplex broadcast service for automatically recording in accordance with the preferences of the viewer in each area without need to create and process the index data 22 at the respective community FM stations 4a, 4b and 4c but only by processing the content data 21 if necessary.

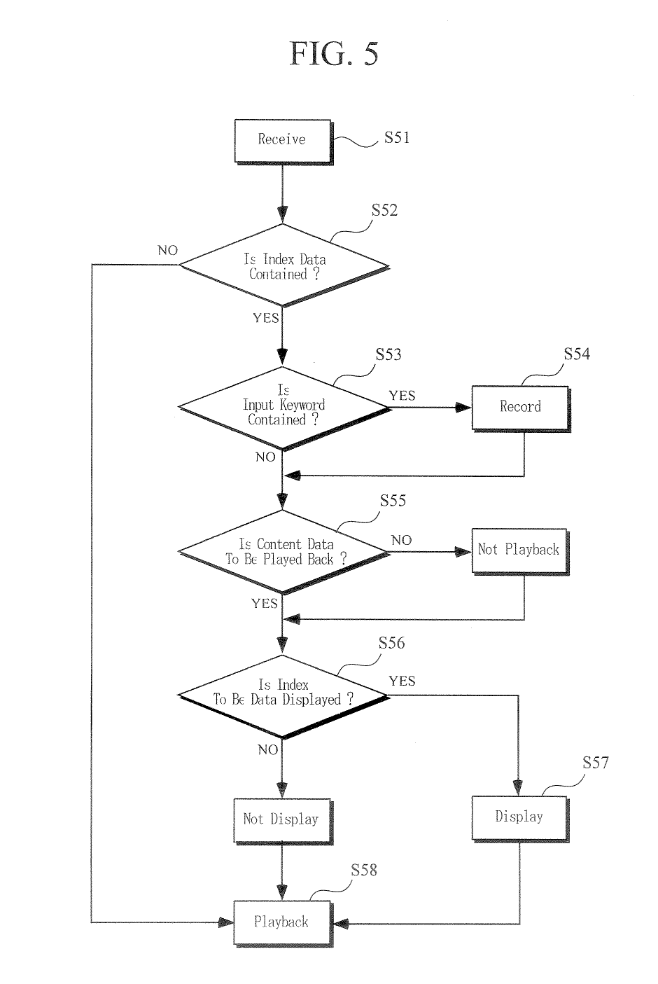

Next, the recording method by the use of the receiver in accordance with the present embodiment will be explained. FIG. 5 is a flow chart for showing the recording method by the use of the receiver in accordance with the present embodiment.

In the case of the receiver 5 as shown in FIG. 3, it is possible to play back an FM multiplex broadcast, display character data on the display, record a predetermined item of content data 21 and so forth by a step (S51) of receiving the FM broadcast, a step (S52) of determining whether or not the index data 22 is contained, a step (S53) of determining whether or not the keyword(s) as input are contained, a step (S54) of recording the predetermined item of content data 21, a step (S55) of determining whether or not to play back the content data 21, a step (S56) of determining whether or not to display the index data 22, a step (S57) of displaying the index data 22, a step (S58) of playing back the content data 21.

In step (S52), it is determined whether or not the index data 22 is contained. When the index data 22 is not contained, it is not an FM multiplex broadcast, and thereby the process proceeds to step (S58) in which it is simply played back. When the index data 22 is contained, the process proceeds to step (S53) in which it is determined whether or not the predetermined keyword(s) as input are contained in the index data 22 as received.

In step (S53), it is determined whether or not the predetermined keyword(s) as input are contained in the index data 22 as received, and when the predetermined keyword(s) are contained the process proceeds to step (S54) in which the corresponding item of the content data 21 is recorded. Furthermore, the process proceeds to step (S55) in which it is determined whether or not to play back the corresponding item of the content data 21 at the same time as recording. Then, when the predetermined keyword(s) are not contained, the process proceeds to step (S55) in which it is determined whether or not to play back the content data 21 as received.

In step (S55), it is determined whether or not to play back the content data 21 as received, and when it is to be played back the process proceeds to step (S56) in which it is determined whether or not to display the index data 22. Incidentally, even when it is not to be played back, it may be desired to enjoy only text broadcasting, and thereby the process proceeds to step (S56) in which it is determined whether or not to display the index data 22.

In step (S56), it is determined whether or not to display the index data 22 on the display, and when it is to be displayed the process proceeds to step (S57) followed by finally playing back in step (S58). On the other hand, even when it is not to be displayed, the process is followed also by finally playing back in step (S58).

As has been discussed above, in accordance with the receiver of the present embodiment, it is possible not only to enjoy an FM broadcast or an FM multiplex broadcast in a conventional manner, but also to search the index data 22 in accordance with the condition given by the viewer, and it is possible to play back or store only particular information contained in the content data 21 in accordance with the search result.

### Practical Industrial Applicability

In accordance with the FM multiplex broadcasting system and FM multiplex broadcasting provision method of the present invention, the central server can centrally create or manage the data for FM multiplex broadcast in order that it is possible to play back or store particular information contained in the content data, and thereby the FM multiplex broadcast can be provided in which only particular information is played back or stored in accordance with the condition given by the viewer, while lessening the load on the community FM stations.

In addition to this, the data for FM multiplex broadcast in accordance with the present invention contains information on the title, artist name, broadcast start time, broadcast end time, length and other relevant data, and thereby it is possible to identify particular information in accordance with the condition given by the viewer, and play back or store only the particular information on the basis of the identification result.

Furthermore, in accordance with the receiver of the present invention, it is possible not only to enjoy an FM broadcast or an FM multiplex broadcast in a conventional manner, but also to search the index data in accordance with the condition given by the viewer, and it is possible to play back or store only particular information in accordance with the search result.

1: An FM multiplex broadcasting system comprising:
a central server operable to create or manage data for FM multiplex broadcast; and
a community server connected to said central server by wired or wireless connections,
wherein said data for FM multiplex broadcast is transmitted from said central server to said community server, and
wherein an FM multiplex broadcast containing said data for FM multiplex broadcast is provided for a particular area through said community server.

2: The FM multiplex broadcasting system as claimed in claim 1 wherein information provided on said community server side can be inserted into said data for FM multiplex broadcast.

3: The FM multiplex broadcasting system as claimed in claim 1 wherein said data for FM multiplex broadcast is composed of content data and index data which includes information about said content data.

4: The FM multiplex broadcasting system as claimed in claim 3 wherein said index data is broadcasted a predetermined period before said content data is broadcasted.

5: An FM multiplex broadcasting provision method comprising:
a step of creating or managing data for FM multiplex broadcast on a central server side;
a step of transmitting said data for FM multiplex broadcast from said central server to a community server located in each area; and
a step of providing an FM multiplex broadcast containing said data for FM multiplex broadcast for a particular area through said community server.

6: The FM multiplex broadcasting provision method as claimed in claim 5 further comprising a step of inserting information provided on said community server side into said data for FM multiplex broadcast.

7: The FM multiplex broadcasting provision method as claimed in claim 5 wherein said data for FM multiplex broadcast is composed of content data and index data which includes information about said content data.

8: The FM multiplex broadcasting provision method as claimed in claim 7 wherein said index data is broadcasted a predetermined period before said content data is broadcasted.

9. A receiver for FM multiplex broadcasts including content data and index data containing information about said content data, comprising:
a receiving unit operable to receive said FM multiplex broadcasts;
a condition setting unit which is used to input the condition for searching said index data;
a search unit operable to search said index data on the basis of said search condition; and
a storage unit operable to store the content data associated with said index data on the basis of the search result.

10: The receiver as claimed in claim 9 further comprising a playback unit operable to play back desired content data on the basis of said search result.

11. The receiver as claimed in claim 9 further comprising a display for displaying desired index data on the basis of said search result.

12: The FM multiplex broadcasting system as claimed in claim 2 wherein said data for FM multiplex broadcast is composed of content data and index data which includes information about said content data.

13: The FM multiplex broadcasting provision method as claimed in claim 6 wherein said data for FM multiplex broadcast is composed of content data and index data which includes information about said content data.
